(19) United States
(12) Patent Application Publication
(10) Pub. No.: US 2025/0194594 A1
(43) Pub. Date: Jun. 19, 2025

(54) ATTRACTANT COTTON SEED BUG, OXYCARENUS Hyalinipennis, AND USES THEREOF

(71) Applicant: The United States of America, as represented by the Secretary of Agriculture, Washington, DC (US)

(72) Inventors: AIJUN ZHANG, BELTSVILLE, MD (US); MOHAMED SAVEER AHMED, BELTSVILLE, MD (US)

(21) Appl. No.: 18/978,133

(22) Filed: Dec. 12, 2024

Related U.S. Application Data
(60) Provisional application No. 63/610,109, filed on Dec. 14, 2023.

(51) Int. Cl. A01N 37/02; A01M 1/02; A01M 1/10; A01M 1/20; A01N 27/00; A01N 35/02; A01P 19/00

(52) U.S. Cl. CPC A01N 37/02; A01M 1/02; A01M 1/10; A01M 1/2005; A01N 27/00; A01N 35/02; A01P 19/00

(57) ABSTRACT

Disclosed herein are cotton seed bug (CSB) Oxycarenus hyalinipennis-attracting compositions, repelling compositions, and oviposition compositions. Disclosed also are methods for detecting the presence of CSB in a field containing at least one plant or plant part, using such CSB-attracting compositions, and devices comprising such CSB-attracting compositions.

### CROSS REFERENCE TO RELATED APPLICATIONS

This application claims priority benefit from U.S. Provisional Application No. 63/610,109, filed 14 Dec. 2023. The contents of this patent application are hereby expressly incorporated by reference in their entirety.

### FIELD

The disclosure relates generally to cotton seed bug (CSB)-attracting compositions and methods for detecting, monitoring and/or controlling CSB in a field.

### BACKGROUND

U.S. cotton production was valued at over 4.6 billion dollars in 2020, with the cotton industry accounting for more than $21 billion in products and services annually. Insects and mites cost cotton producers about $1.3 billion during 2019 in yield losses and control costs. The cotton seed bug (CSB), Oxycarenus hyalinipennis (Costa), is a polyphagous pest with a worldwide distribution. CSB is an invasive insect native to southern Europe and North Africa. CSB feeds on plants in the mallow family (Malvaceae). Agricultural commodities include cotton (Gossypium spp.), okra, hibiscus, sterculia, cocoa, primrose trees, and kenaf. In cotton, CSB causes distortions in seeds and moldiness in flowers that ultimately decreases crop yield. CSB-infested plants in the family Malvaceae were reported in Florida in 2010 and southern California in 2019. CSB is a major economic threat to the U.S. cotton industry, which was estimated to cause 15% weight loss in cotton seed, decreased seed germination by up to 88%, and reduced oil seed (in 2019 the value of cottonseed produced in the U.S. was 1 billion USD).

CSB poses a significant threat to the U.S. cotton industry. Based on the availability of suitable hosts and climates, and the lack of natural enemies, there is a high likelihood that CSB will establish itself throughout the southern regions of the U.S. As of today, there are no effective tools for the detection and monitoring of CSB infestation.

Thus, new methods for detecting and controlling CSB are needed.

### SUMMARY

Provided herein are cotton seed bug (CSB), Oxycarenus hyalinipennis-attracting compositions for detecting, monitoring, and/or controlling CSB, methods, and devices for using such CSB-attracting compositions to treat or prevent a CSB infestation in fields, plants, or plant parts.

In an embodiment, the disclosure relates to a cotton seed bug (CSB) attracting composition comprising at least one CSB attractant selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or combinations thereof, and optionally an insecticide. In some embodiments, the CSB attracting composition comprises at least two CSB attractants selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, or α-pinene. In some embodiments, the at least two CSB attractants are present in a ratio of about 1:about 2:about 7.

In an embodiment, the disclosure relates to a method for attracting and/or monitoring the presence of cotton seed bug (CSB) in a field, plant, or plant part, the method comprising placing an effective amount of at least one CSB attractant selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof on a surface in a field containing at least one plant or plant part, and determining that at least one CSB is attracted when at least one CSB is observed touching or near the surface containing the CSB attractant. In some embodiments, the disclosure relates to a method for controlling CSB infestation, by placing on the surface at least one CSB attractant and at least one insecticide. The field may contain at least one Malvaceae plant or plant part.

In an embodiment, the disclosure relates to devices for attracting, detecting, monitoring, or controlling CSB infestation in a field or plant part, the device containing an effective amount of at least one CSB attractant selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof, and a trap. In some embodiments, the disclosure relates to a method for controlling CSB infestation, by placing in the device at least one CSB attractant and at least one insecticide. In some embodiments, the field comprises at least one Malvaceae plant or plant part.

### BRIEF DESCRIPTION OF THE DRAWINGS

FIG. 1 depicts the reconstructed GC-MS traces (total ion) of cotton seed bug whole body volatile extract of virgin male (top) versus nymph exuviae extract (bottom) on HP-5 MS capillary column. 1. (E)-2-Hexenal, 2. α-Pinene, 3. 4-Oxo-(E)-2-hexenal, 4. (E)-2-Hexenyl acetate, 5. (E)-2-Octenal, 6. 4-Oxo-(E)-2-octenal, 7. (E)-2-Octenyl acetate, 8. (E)-2-Decenal, 9. 4-Oxo-(E)-2-decenal, 10. (E)-α-Bergamotene, 11. (Z, E)-α-Farnesene, 12. Sesquiterpene 1, 13. Sesquiterpene 2.

FIG. 2 depicts the reconstructed GC-MS traces (total ion) of cotton seed bug headspace volatile extract of calm virgin male (top) versus agitated virgin male extract (bottom) on HP-5 MS capillary column. 1. (E)-2-Hexenal, 2. α-Pinene, 3. 4-Oxo-(E)-2-hexenal, 4. (E)-2-Hexenyl acetate, 5. (E)-2-Octenal, 6. 4-Oxo-(E)-2-octenal, 7. (E)-2-Octenyl acetate, 10. (E)-α-Bergamotene, 11. (Z,E)-α-Farnesene, 12. Sesquiterpene 1, 13. Sesquiterpene 2.

FIG. 3 depicts the reconstructed GC-MS traces (total ion) of cotton seed bug headspace volatile extract of agitated virgin male (top) versus SPME extract of apple fruit (bottom) on HP-5 MS capillary column.

FIG. 4 depicts the chemical structures of the volatiles of identified and confirmed by authentic standards and natural compounds existed in natural plants from nymphs, exuviae, and adult of O. hyalinippenis.

FIG. 5A to FIG. 5C depict graphs of the amounts of aggregation pheromone and alarm pheromone produced by cotton seed bugs (CSBs). FIG. 5A results from ten virgin male CSBs. FIG. 5B results from ten virgin female CSBs. FIG. 5C results from five virgin males and five virgin female CSBs. Volatiles were collected at 2 hours after agitation and then in calm condition at 24 hours, respectively

FIG. 6 depicts a schematic representation of the dual-choice refuge and oviposition assays used to evaluate attraction and oviposition behavior in cotton seed bugs (CSBs).

FIG. 7 depicts a schematic representation of the Y-tube olfactometer used in the cotton seed bug (CSB) behavioral assays.

FIG. 8A and FIG. 8B depict graphs of the behavioral responses of nymphs (n=15), mated males (n=15), and female (n=15) CSBs to the blank vials. FIG. 8A shows the amount of Responders: The percentage of insects that were activated and made a choice. FIG. 8B shows the Side preference: The percentage of insects that selected either side. No statistically significant differences were observed according to Fisher's Exact Test (two-tailed).

FIG. 9A and FIG. 9B depict graphs of the behavioral responses of cotton seed bugs evaluated in a dual-choice refuge assay with the following groups: nymphs (n=30), unmated males (n=30), mated males (n=30), unmated females (n=30), and mated females (n=30). FIG. 9A shows data for responders: The percentage of insects that were activated and made a choice between the control and treatment sides. FIG. 9B shows side Preference: The percentage of insects that selected either the control or treatment side. Statistically significant differences were observed according to Fisher's Exact Test (two-tailed).

FIG. 10A and FIG. 10B depict graphs of the behavioral responses of nymphs, unmated females, and mated females assessed in control olfactometer bioassays with clean filter papers on both sides (n=15). FIG. 10A shows data for responders. FIG. 10B shows preference data.

FIG. 11A and FIG. 11B depict graphs of the behavioral response of Nymph (n=20), Unmated female (n=20), and mated female (n=20) towards Exuviae Extracts in a Y-tube olfactometer. FIG. 11A shows data for responders. A response was defined as a CSB making a choice by moving at least 5 cm into either arm of the olfactometer within the observation period.

FIG. 11B shows side preference data. The side preference was determined by the CSB's choice between the exuviae extract arm and the control arm. Nymphs and gravid females are significant at ** P=0.007, and *P=0.026, respectively according to Fisher exact test.

FIG. 12A and FIG. 12B depict graphs of the average number of eggs per female. FIG. 12A shows the results for eggs per female laid on cotton seeds positioned above a filter paper without solvent (filter blank) compared to a solvent blank (n=15). FIG. 12B shows the results for eggs per female laid on cotton seeds positioned above the solvent blank and the exuviae extract side (n=30), with a significant difference observed (P<0.0001) according to a Mann-Whitney test (two-tailed).

FIG. 13A and FIG. 13B depict graphs of the behavioral responses of nymph (n=20), male (n=20), and female (n=20) towards calm nymph associated VOCs in a Y-tube olfactometer. FIG. 13A shows data for Responders: The percentage of insects that were activated and made a choice to either go to control or treatment side. FIG. 13B shows side preference: The percentage of insects that selected either side. Statistically significant differences were observed according to Fisher's Exact Test (two-tailed).

FIG. 14A and FIG. 14B depict graphs of the behavioral response of nymph (n=20), male (n=20), and female (n=20) towards calm male (20)+Female (20) VOCs in a Y-tube olfactometer. FIG. 14A shows data for Responders: The percentage of insects that were activated and made a choice to either go to control or treatment side. FIG. 14B shows side preference: The percentage of insects that selected either side. Statistically significant differences were observed according to Fisher's Exact Test (two-tailed).

FIG. 15A and FIG. 15B depict graphs of the behavioral response of nymph (n=20), male (n=20), and female (n=20) towards Agitated male (20)+Female (20) VOCs in a Y-tube olfactometer. FIG. 15A shows data for Responders: The percentage of insects that were activated and made a choice to either go to control or treatment side. FIG. 15B shows data for side preference: The percentage of insects that selected either side. Statistically significant differences were observed according to Fisher's Exact Test (two-tailed).

FIG. 16A and FIG. 16B depict graphs of the behavioral response of male (n=25), and female (n=25) towards calm male (40) VOCs in a Y-tube olfactometer. FIG. 16A shows responders: The percentage of insects that were activated and made a choice to either go to control or treatment side. FIG. 16A show side preference: The percentage of insects that selected either side. Statistically significant differences were observed according to Fisher's Exact Test (two-tailed).

FIG. 17A and FIG. 17B depict graphs of the behavioral response of male (n=25), and female (n=25) towards agitated male (40) VOCs in a Y-tube olfactometer. (a) Responders: The percentage of insects that were activated and made a choice to either go to control or treatment side. (b) Side preference: The percentage of insects that selected either side. Statistically significant differences were observed according to Fisher's Exact Test (two-tailed).

### DETAILED DESCRIPTION

The present disclosure relates to cotton seed bug (CSB)-attracting compositions, methods for using such compositions to attract CSB in a field containing at least one plant or plant part, and devices comprising such compositions and a trap.

The cotton seed bug (CSB), Oxycarenus hyalinipennis (Costa), is an invasive insect native to southern Europe and North Africa. CSB invaded Florida in 2010 and California in 2019. CSB poses a significant threat to the U.S. cotton industry. Potential pest outbreak of CSB has caused critical concern for the economic damage of the cotton production. Based on host and climate availabilities and lack of natural enemies, CSB has a high likelihood for establishment throughout the southern regions in the U.S. CSB infestations were discovered by visual inspection from residential properties in Florida and California.

The cottonseed bug is a seed feeder of more than 35 reported host plants from the Malvaceae family, especially cotton (Gossypium spp.), hibiscus (Hibiscus spp.), and okra (Abelmoschus spp). The preferred reproductive host appears to be cotton. It has been reported that O. hyalinipennis may also feed on hosts outside of Malvaceae including apple, corn, avocado, pear, cowpea, grape, and milkweed. Approximately 70% of reported host plants occur within the United States. Seeds must be present for the cottonseed bug to reproduce.

Malvaceae, the hibiscus, or mallow, family (order Malvales) contains around 243 genera and at least 4,225 species of herbs, shrubs, and trees. Representatives of the mallow family are found throughout the world with the exception of the coldest parts. A number of Malvaceae species are economically important, including cotton (various Gossypium species), cacao (Theobroma cacao), linden (Tilia species), durian (Durio species), Hibiscus, and okra (Abelmoschus esculentus).

Until today, there are no effective tools to satisfy needs for CSB infestation detection and monitoring. An effective infestation detection tool based on attractive olfactory chemical cues is urgently needed for a more accurate survey and management of this invasive species.

All of E2-octenal, 4-oxo-E2-octenal, E2-octenyl acetate, 4-oxo-E2-hexnal, E2-hexenyl acetate, E2-hexenal, E2-decenal, 4-oxo-E2-decenal, and α-pinene are naturally occurring, readily-biodegradable, and generally regarded as safe to humans. Therefore, the potential exists to develop at least one of these compounds or a mixture of at least two of these compounds as environmentally-sound sprayable formulations for monitoring, detecting, and/or controlling CSB. This would be a safer alternative to the synthetic insecticides currently used to control agricultural pests.

The data disclosed herein demonstrates that compositions comprising at least one of E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof attract CSB.

A member of the medium-chain aldehydes, (E)-2-octenal is also known as trans-2-octenal. Medium-chain aldehydes have a chain length containing between 6 and 12 carbon atoms. 2-octenal is practically insoluble (in water) and an extremely weak basic (essentially neutral) compound (based on its pKa).

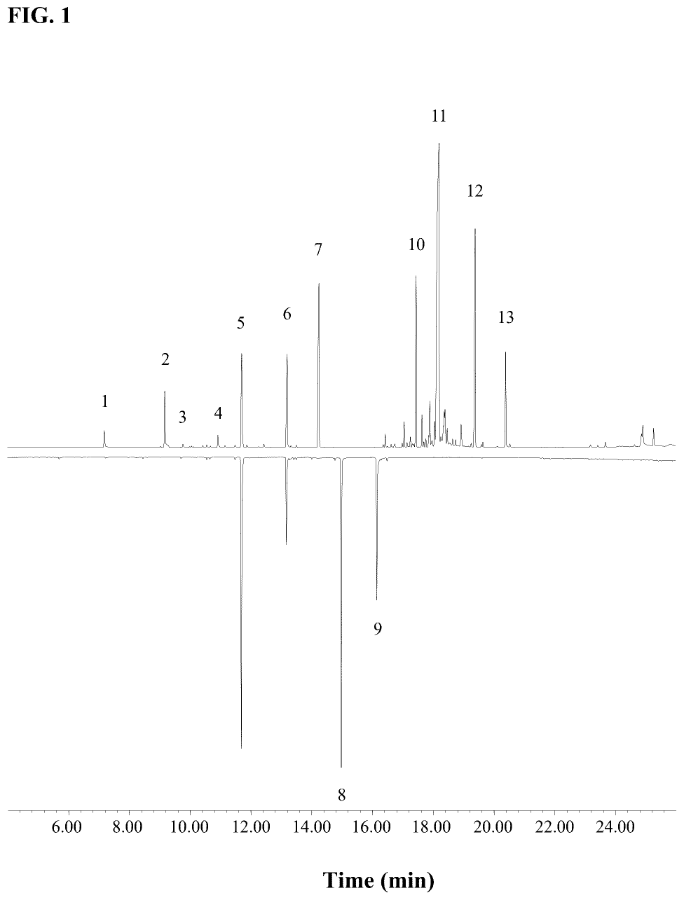

As shown in FIG. 1, 13 different compounds were identified in the total ion reconstructed GC-MS traces of cotton seed bug on a HP-5 MS capillary column. The top trace in the figure represents volatile extracts from whole-body virgin females, and the bottom trace in the figure represents volatile whole-body extracts from 4-5 instar nymphs. The peaks were numbered, and the identity of each is: 1. (E)-2-Hexenal, 2. α-Pinene, 3. 4-Oxo-(E)-2-hexenal, 4. (E)-2-Hexenyl acetate, 5. (E)-2-Octenal, 6. 4-Oxo-(E)-2-octenal, 7. (E)-2-Octenyl acetate, 8. (E)-2-Decenal, 9. 4-Oxo-(E)-2-decenal, 10. (E)-α-Bergamotene, 11. (Z, E)-α-Farnesene, 12. Sesquiterpene 1, 13. Sesquiterpene 2.

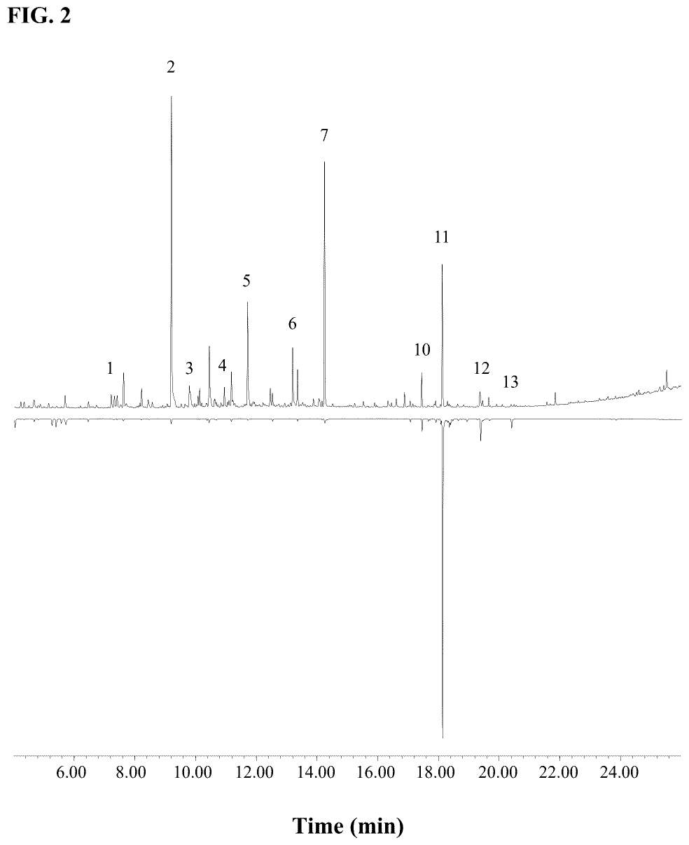

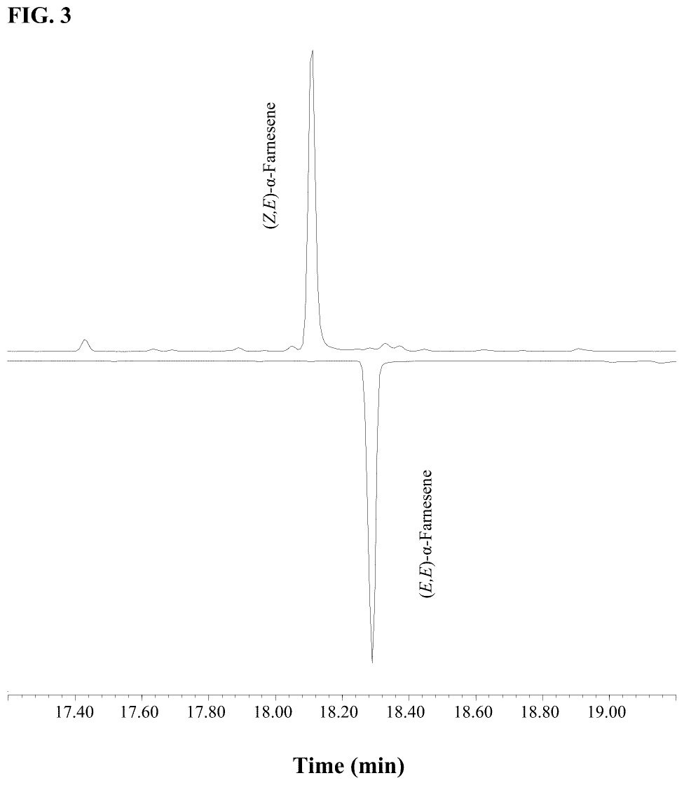

As shown in FIG. 2, headspace volatile extract of calm virgin male (top) versus agitated virgin male extract (bottom) on HP-5 MS capillary column. 1. (E)-2-Hexenal, 2. α-Pinene, 3. 4-Oxo-(E)-2-hexenal, 4. (E)-2-Hexenyl acetate, 5. (E)-2-Octenal, 6. 4-Oxo-(E)-2-octenal, 7. (E)-2-Octenyl acetate, 10. (E)-α-Bergamotene, 11. (Z,E)-α-Farnesene, 12. Sesquiterpene 1, 13. Sesquiterpene 2. Graphs of the cotton seed bug headspace volatile extract of agitated virgin male (top) versus SPME extract of apple fruit (bottom) on HP-5 MS capillary column are shown in FIG. 3.

The measured behavioral responses under different conditions are described here.

CSB Oviposition attractant: The results shown above demonstrated that male and female CSBs released seven volatile compounds (compounds 1-7) in comparable amounts as aggregation pheromone in the early retention time region and four major sesquiterpenes (compounds 10-13) as alarm pheromone in the later retention time region as detected by GC-MS from whole-body hexane extracts (FIG. 1).

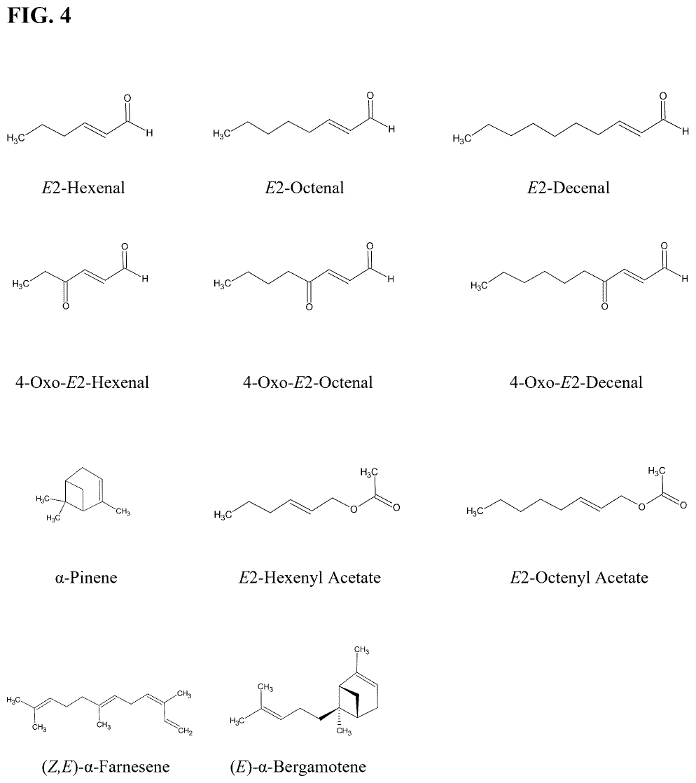

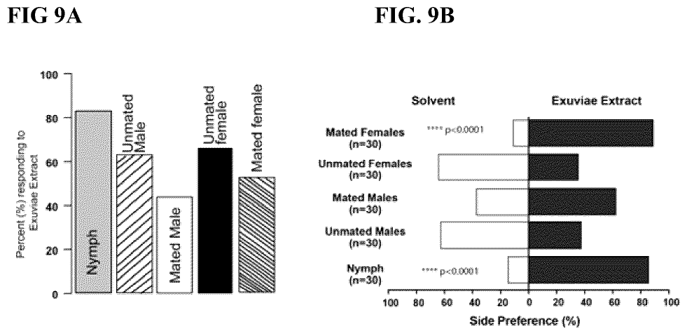

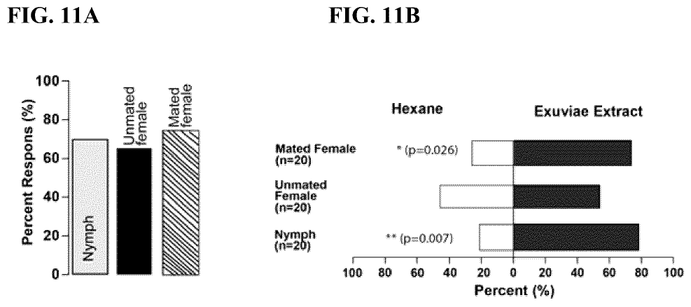

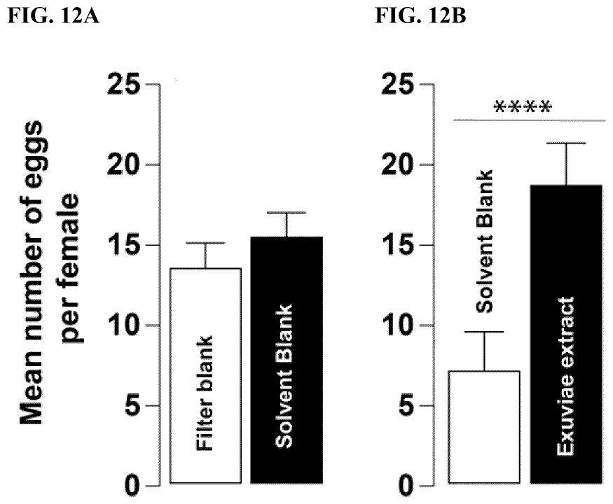

The results shown in FIG. 9A, FIG. 9B, FIG. 11A, FIG. 11B, FIG. 12A, and FIG. 12B clearly demonstrate that juvenile-associated odors (exuviae extracts, FIG. 4 compounds 5, 6, 7, and 8) play a critical role as oviposition pheromone, significantly influencing behavioral and reproductive decisions of cotton seed bugs (CSBs), particularly in gravid females and nymphs.

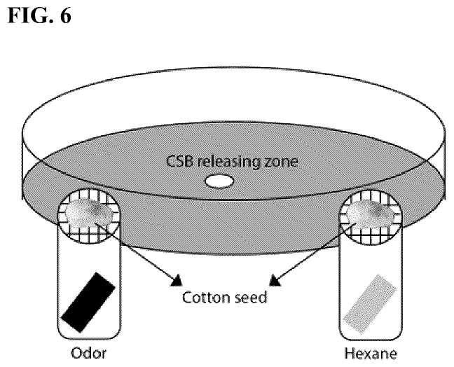

Gravid females and nymphs exhibited a significant preference for the exuviae extract side, both in a dual-choice refuge, and Y-tube olfactometer assays (Fisher's exact test: P<0.0001 and P<0.007, respectively FIGS. 4 and 6), underscoring their strong attraction to exuviae-associated cues.

Furthermore, this attraction extended to oviposition behavior, where gravid females laid significantly more eggs on cotton seeds exposed to exuviae odors compared to solvent controls (Mann-Whitney test: P<0.0001; FIG. 12A and FIG. 12B). In contrast, unmated and mated males, as well as unmated females, showed no significant preference, indicating that this conspecific attraction is closely tied to the reproductive and ecological needs of specific life stages.

CSB Aggregation and Alram Pheromone: The results demonstrated that volatile organic compounds (VOCs) emitted by calm (aggregation pheromone, compounds 1, 2, 3, 4, 5, 6, and 7 in FIG. 2), and agitated (alarm pheromone, compounds, 10, 11, 12, and 13 in FIG. 2), cotton seed bugs (CSBs) elicit distinct behavioral responses, including attraction and avoidance based on the life stage and sex of conspecifics. Major sesquiterpenes compound 11 was confirmed as (Z,E)-α-Farnesene by comparison of GC-MS spectra and KI with natural compounds existed in apple fruit (FIG. 3).

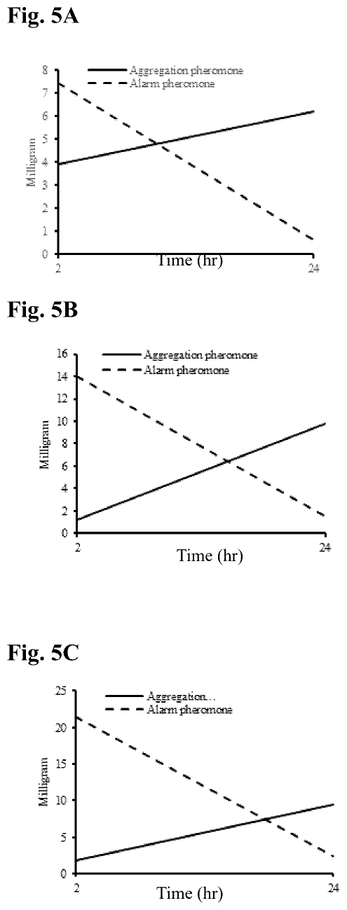

Chemical structures of aggregation pheromones and alarm pheromones were listed in FIG. 4. Amounts of aggregation pheromone and alarm pheromone produced by cotton seed bugs showed inverse relationship. As shown in FIG. 5A to FIG. 5C, the amount of aggregation pheromone (compounds 1-7), increased over time, while the amount of alarm pheromone (compounds 10-13) decreased over time from 2 hours to 24 hours.

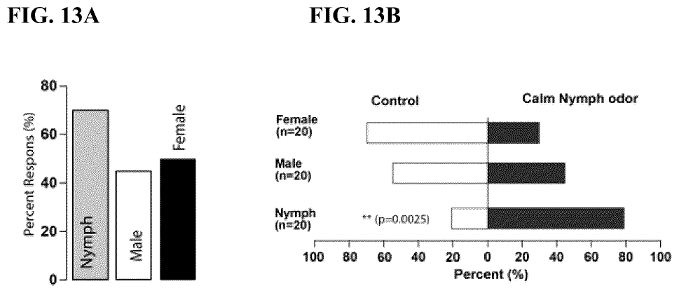

As shown in FIG. 13A and FIG. 13B, this disclosure demonstrated that juvenile (nymphs, exuviae, compounds 5, 6, 7, and 8)-associated odors from exuviae extracts significantly attracted 70% of 4th/5th instar nymphs, with a strong preference for the nymph odor side (Fisher's exact test, p=0.0025) in a Y-tube olfactometer bioassay. However, males and females showed no significant preference towards the juvenile odors under similar conditions.

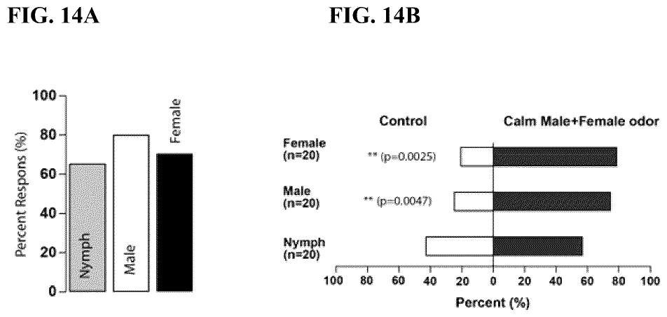

The disclosure also demonstrated that males and females showed a very strong attraction towards the combination of aggregation pheromone (clam male and female odors, compounds 1-7) (Fisher's exact test, two-tailed: p=0.0047 and p=0.0025, respectively; FIG. 14A and FIG. 14B). In contrast, nymphs did not exhibit a significant preference for male and female odors. This strongly indicates that the odors emitted by the adult male and females signify the aggregation pheromone as they strongly attract both males and females.

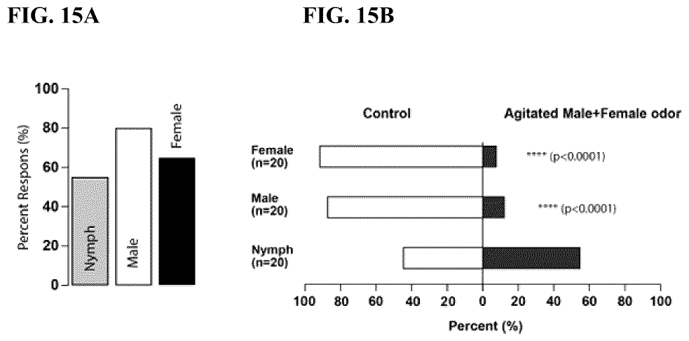

The disclosure demonstrates that the VOCs emitted by agitated males and females functioned as alarm pheromone and repellents (compounds 10-13, mainly compound 11). Over 90% of adult males and females actively avoided agitated male-female associated odors (Fisher's exact test, p<0.0001, FIG. 15A and FIG. 15B), establishing these VOCs as potent repellents for pest management applications. Interestingly, male-female agitated odors did not affect the behavior of the nymphs as they showed no preference towards the odors of alarm pheromone in Y-tube assay.

Taking together, the data shown here clearly demonstrates that the use of calm-associated VOCs and Juvenile associated odors to aggregate nymph, male and female CSBs for trapping or infestation detection and population monitoring, while the use of agitated-associated VOCs (alarm pheromone) to deter male and female CSBs from specific areas (repellent). These discoveries highlight the distinct behavioral responses to VOC profiles under different physiological states, providing a foundation for the development of novel pest management strategies, such as attractants, repellents, or behavioral modulators targeting CSBs.

The compounds (E)-2-Hexenal, α-Pinene, 3. 4-Oxo-(E)-2-hexenal, (E)-2-Hexenyl acetate, (E)-2-Octenal, 6. 4-Oxo-(E)-2-octenal, (E)-2-Octenyl acetate performed as CSB attraction pheromones. The compounds (E)-α-Bergamotene, (Z, E)-α-Farnesene, Sesquiterpene 1, Sesquiterpene 2 performed as alarm (repellent) pheromones. The compounds (E)-2-Octenal, 4-Oxo-(E)-2-octenal, (E)-2-Octenyl acetate, (E)-2-Decenal performed as oviposition pheromones.

As shown here, at least one of (E)-2-Hexenal, α-Pinene, 3. 4-Oxo-(E)-2-hexenal, (E)-2-Hexenyl acetate, (E)-2-Octenal, 6. 4-Oxo-(E)-2-octenal, and (E)-2-Octenyl acetate attract CSBs in a field having at least one cotton seed plant. The compounds (E)-α-Bergamotene, (Z, E)-α-Farnesene, Sesquiterpene 1, and Sesquiterpene 2 performed as alarm (repellent) pheromones. The compounds (E)-2-Octenal, 4-Oxo-(E)-2-octenal, (E)-2-Octenyl acetate, and (E)-2-Decenal performed as oviposition pheromones. When greater than one CSB attractant compound is present, each compound may be present in a ratio ranging from 1 to 7. For example, when two compounds are present, the ratio of compounds may be 1:7, 1:6, 1:5, 1:4, 1:3, 1:2, 1:1 (and vice versa) or 2:7, 2:6:2:5, 2:4, 2:3 (and vice versa), etc. In one aspect of the invention, a composition is provided in a ratio of 1:2:7 of E2-octenal, 4-oxo-E2-octenal, and E2 octenyl acetate.

A CSB attractant, alone or in combination with other CSB attractants may be included in various types of suitable devices known in the art such as rubber septa, polyethylene microtubes, polypropylene microtubes, cellulose strips, plastic vials, PVC pouches, and polymeric matrices. CSB attractants according to the present invention may further be included in dosage forms or dispensers providing controlled release, e.g., microcapsules, plastic laminate flakes, polymethacrylate beads, polymer waxes, or polyethylene tubing.

Devices comprising the CSB attractants taught herein may be an insect trap to capture CSB, such as, e.g., a sticky card trap, a delta trap, a bucket trap, a funnel trap, a bottle trap, or a castellation trap. A suitable trap preferably permits easy entrance by the CSB, but difficult exit for a CSB.

The CSB attractant may be present in the device together with an insecticide. Suitable insecticides are organophosphates, pyrethroids, and neonicotinoids In particular, the insecticide may be at least one of propargite (sulfite), buprofezin (insect growth regulator), thiamethoxam (seed trt.) (neonicotinoid), fenpropathrin (pyrethroid).

Unless otherwise explained, all technical and scientific terms used herein have the same meaning as commonly understood by one of ordinary skill in the art to which this disclosure belongs.

The singular terms “a”, “an”, and “the” include plural referents unless context clearly indicates otherwise. Similarly, the word “or” is intended to include “and” unless the context clearly indicate otherwise.

As used herein, the term “about” is defined as plus or minus ten percent of a recited value. For example, about 1.0 g means 0.9 g to 1.1 g.

As used herein, the terms “E2-Octenal,” “(E)-2-octenal,” and “trans-2-octenal” are used interchangeably.

As used herein, the terms “4-oxo-E2-octenal” and “4-Oxo-E2-8: Ald” are used interchangeably.

As used herein, the terms “E2-hexenal,” “(E)-2-Hexanal,” and “trans-2-hexenal” are used interchangeably.

As used herein, the terms “E2-octenyl acetate,” “(E)-2-octenyl acetate,” and “trans-2-octenyl acetate” are used interchangeably.

As used herein, the terms “E2-decenal” and “trans-2-decenal” are used interchangeably.

As used herein, the terms “4-oxo-E2-hexenal” and “4-Oxo-(E)-2-hexenal” are used interchangeably

As used herein, the terms “4-oxo-E2-decenal” and “4-oxo-(E) 2-decenal are used interchangeably.

As used herein, the terms “α-pinene,” “alpha-Pinene,” “(+)-2-Pinene,” and “2,6,6-Trimethylbicyclo[3.1.1]hept-2-ene” are used interchangeably.

As used herein, the terms “E2-hexenyl acetate,” “trans-2-hexenyl acetate,” and “(E)-2-hexen-1-yl acetate” are used interchangeably.

As used herein, the terms “E2-octenyl acetate” and “trans-2-octenyl acetate” are used interchangeably.

As used herein, a “CSB attractant” or a “CSB attractant compound” are used interchangeably and refer to one or more compounds that attract at least one CSB. As taught herein, the CSB attractant or CSB attractant compound is at least one of E2-octenal, 4-oxo-E2-octenal, E2-octenyl acetate, 4-oxo-E2-hexnal, E2-hexenal, E2-hexenyl acetate, E2-devenal, 4-oxo-E2-decenal, α-pinene, or a mixture thereof. In some embodiments of the disclosure, (EE)-α-farnesene, farnesene isomer, or sesquiterpene are not used as CSB attractants.

The amount of CSB attractant necessary varies by the field conditions, but the minimum effective amount for each CSB attractant compound is about 10 μg to about 10 mg.

Mention of trade names or commercial products in this disclosure is solely for the purpose of providing specific information and does not imply recommendation or endorsement by the U.S. Department of Agriculture.

Composition is applied to one or more of untreated lumber, treated lumber, a wood beam, a wood board, cardboard, particle board, a joist, a stud, a baseboard, wood trim, a hardwood floor, a window sill, a screen, a porch floor, a deck, a door, a wall, a ceiling, interior furniture, or exterior furniture. composition is applied to one or more of a carpet, a curtain, a rug, padded furniture, a cushion, a mattress, a box spring, a mattress cover, a bedbug repellent mattress pad, a bed sheet, a blanket, a pillow, a doll, a stuffed animal, an insect trap, or a net.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

The term “consisting essentially of” excludes additional method (or process) steps or composition components that substantially interfere with the intended activity of the method (or process) or composition, and can be readily determined by those skilled in the art (for example, from a consideration of this disclosure or practice of the material disclosed herein).

According to MPEP 2173.05 (i), the current view of the courts is that there is nothing inherently ambiguous or uncertain about a negative limitation. So long as the boundaries of the patent protection sought are set forth definitely, albeit negatively, the claim complies with the requirements of 35 U.S.C. 112 (b) or pre-AIA 35 U.S.C. 112, second paragraph.

### EXAMPLES

Having now generally described this invention, the same will be better understood by reference to certain specific examples, which are included herein only to further illustrate the invention and are not intended to limit the scope of the invention as defined by the claims.

### Example 1

### Identification of Pheromone Compounds

Volatile compounds obtained from male and female O. hyalinipennis, or the metathoracic scent glands (MTG) of the cotton seed bugs were dissected were compared, and identified using GC-MS.

Cotton seed bugs were originally obtained from a Primrose Tree infested with O. hyalinipennis in Irvine, Orange County, California on Oct. 24, 2021 (Coordinates of the location: 33° 2′ 8″ N 117° 46′ 23″ W). The primrose trees yield small brown fruits that resemble cotton balls, which are shed during autumn. The seeds inside the shells serve as the primary food source for CSB.

After being collected from California, the CSB adults were held in a quarantine room at the U. S. Department of Agriculture (USDA), Agricultural Research Service (ARS), Invasive Insect Behavior and Biological Control Laboratory (IIBBL). The CSB adults were reared in a clear plastic rectangular container (42 oz, Pioneer Plastic, North Dixon, Kentucky, USA) with a decorative inset lid. The container was constructed by drilling four 0.5-inch diameter holes in each of its walls and a single 0.5-inch diameter opening at the lid center. These openings were fitted with a nylon screen (0.3 mm mesh size) affixed securely with hot glue, promoting proper air circulation. The container had access to dry 15-20 cotton seeds (Cotton Fiber Bioscience Research Unit, USDA-ARS, New Orleans, Luisiana, USA), approximately 100 grams of green beans Phaseolus vulgaris (MOM's organic market, College Park, Maryland, USA), and tap water, which was provided in a 15 mL glass bottle equipped with a cotton wick, and both the water and green beans were replaced as needed (about every 3 to 5 days). Maintenance of the O. hyalinipennis colony was achieved by transferring the old cotton seeds with eggs to a new plastic container with fresh cotton seeds, green beans, and water tubes (nymph cage) every 3 to 4 days. In this way, adults with nymphs and eggs were reared in separate containers, labeled with their respective dates, and maintained in a controlled environment chamber at a temperature of 26° C.±1° C., 75% relative humidity (RH), and a 16-hour light: 8-hour dark cycle.

To get virgin males and females, 5th instar nymphs were individually placed into glass vials (7.5 mL). Adult unmated males and females were collected on the day of eclosion (Day-0) and grouped into same plastic container with green beans, water, and 3 to 5 cotton seeds. Then, the fresh exuviae were collected and combined for exuvial extraction. Five days after emergence, two methods were used to obtain mated males and females: (1) short-term mating—a single male and female of the same age were paired in a via for 24 hours before being separated; (2) long-term multiple mating—a male and a female of similar age were continuously housed together in a vial to facilitate multiple mating. All the containers were provided with green beans, water, and 3 to 5 cotton seeds as maintenance of virgin O. hyalinipennis.

To obtain CSB solvent extracts, 10 nymphs (4th and 5th instar), 40 fresh exuviae, and 40 adults (10 each of virgin male, virgin female, mated male, and mated female) were placed into 7.5 mL glass vials separately. Then 100-200 μL of hexane were introduced into each vial, allowing the contents to immerse at room temperature for 30 minutes. After this incubation period, extracts were transferred into new 1.5 mL GC glass vials separately and stored at −30° C. in the freezer until analysis. To check the differences in the volatile chemical components as a result of age of CSB, 5-, 10-, 20-, 30-, and 40-day old virgin and mated male and female whole-body extracts were also prepared.

Chemicals, including α-pinene, 98% CAS 80-56-8; E2-hexenal, 98%, CAS 6728-26-3; E2-hexenyl acetate, ≥98%, CAS 2497-18-9; E2-octenal, ≥95%, CAS 2548-87-0; E-2-decenal, ≥95%, CAS 3913-81-3; as well as HPLC grade solvents hexane and methylene chloride were purchased from Sigma Aldrich (St. Louis, Missouri, USA). E2-octenyl acetate, ≥98%, CAS 2371-13-3 was purchased from the Bedoukian Research, Inc. (Danbury, Connecticut, USA). The C7-C30 saturated alkanes standard mixture was purchased from Fisher Scientific (Waltham, Massachusetts, USA) for the purpose of calculation of Kovats Index.

Other 4-oxo-E2-aldyhedes chemicals, including 4-oxo-E2-hexenal, 4-oxo-E2-octenal, 4-oxo-E2-decenal, are not commercially available and were synthesized in the laboratory using procedures as described by JA Moreira and JG Millar (2005, “Short and simple syntheses of 4-oxo-(E)-2-hexenal and homologs: pheromone components and defensive compounds of Hemiptera,” J. Chem. Ecol. 31 (4): 965-968). Briefly, to N-bromosuccinimide was converted to 4-Oxo-E2-hexenal, 2-n-butylfuran was converted to 4-oxo-E2-octenal, and 2-n-hexylfuran was converted to 4-oxo-E2-decenal by mixing with pyridine, and sequentially adding to a solution of 2-ethylfuran in THF/acetone/water at −15° C. The resulting mixture was stirred for 3 hours at −15° C. and then warmed to room temperature and stirred overnight. The mixture was poured into aqueous HCl (0.5 M, 20 mL) and extracted with ether (3× 20 mL). The combined organic layers were washed with brine, dried over anhydrous MgSO₄, and the solvent was removed by distillation. The crude product was purified by vacuum flash chromatography over silica gel (ether:pentane, 15:85).

An Agilent 8890 GC system equipped with a 5977 Inert Plus Turbo Mass Selective Detector (MSD) in electron ionization (EI) mode, coupled to a HP-5 MS or DB-WAXETR capillary column (60 m×0.25-mm i.d., 0.25-μm film-thickness, Agilent J&W, Santa Clara, California, USA), with helium as carrier (2.0 mL/minute) was used for GC-MS analysis. The oven temperature for HP-5 MS capillary column was started at 40° C. for 5 minutes, then programmed to rise to 280° C. at 15° C./minute, and held for 5 minutes in the splitless mode, while for the DB-WAXETR capillary column, the temperature was started at 40° C. for 2 minutes, then programmed to rise to 240° C. at 15° C./minute and held for 15 minutes. A 70-eV electron beam was employed for sample ionization. The chemical identification of the volatiles was based on comparison of their mass spectra with the NIST and Wiley mass spectral libraries and identities were confirmed by mass spectra and GC retention times of authentic standards on both polar and non-polar GC capillary columns (A. Zhang, et al., 2004, “Sex pheromone of the pink hibiscus mealybug, Maconellicoccus hirsutus, contains an unusual cyclobutanoid monoterpene,” Proc. Natl. Scad. Sci. USA 101 (26): 9601-9606. If no authentic standards were available, identities were achieved by matching the MS spectra as well as calculated and published Kovats Index. The percentages of identified components were determined by using an Agilent 8890 GC coupled to a flame ionization detector (FID) in the splitless mode using a HP-5 MS capillary column and same temperature program as above, but with hydrogen as carry gas (2.0 mL/minute).

The mean number of O. hyalinippenis in different treatment traps (captures/week) in field trials were compared by one-way analysis of variance (ANOVA) followed by Ryan-Einot-Gabriel-Welsch F test (SPSS 10.0 for Windows) following D George and P Mallery (2002, “SPSS for Windows Step by Step: A Simple Guide and Reference,” 11.0 Update. 4th Edition, Allyn & Bacon; Boston, Massachusetts, USA). All statistical comparisons were considered for significance at α=0.05.

The GC-MS analyses of whole-body hexane extracts of CSB male and female adults revealed that seven volatile compounds were eluted in comparable amounts in the early retention time region, and four major sesquiterpenes (molecular weight m/e 204) in the later retention time region in both male and female samples. The top trace in FIG. 1 corresponds to the data from a virgin female. The first seven compounds were identified as E2-hexenal (peak 1), α-pinene (peak 2), 4-oxo-E2-hexenal, (peak 3), E2-hexenyl acetate (peak 4), E2-octenal (peak 5), 4-oxo-E2-octenal (peak 6), and E2-octenyl acetate (peak 7). Identities of these compounds were confirmed by matching mass spectra and GC retention time with standards on both non-polar and polar capillary columns. In the later retention time region, only two sesquiterpenes were identified as E-a-bergamontene (peak 10) and (Z, E)-α-farnesene (peak 11) by matching the mass spectra and Kovats Index. The identify of other two sesquiterpenes (peaks 12 and 13) with molecular weight m/e 204 could not be determined and were marked as unidentified sesquiterpenes. The volatile compounds identified by GC-MS are listed in Table 1 below. The volatile chemical profiles were not significantly different from those of 5-, 10-, 20-, 30-, and 40-day old virgin mated male and female whole-body extracts.

Volatile chemical components of nymphs and exuviae (exoskeleton) were also analyzed. The hexane extracts of 4-5 instar nymphs and exuviae contain four major peaks (FIG. 1, bottom trace). The first two compounds are E2-octenal and 4-oxo-E2-octenal that are same as peak 5 and peak 6 in whole-body extracts, while two additional peaks that were only produced with nymph extracts and exuviae are identified as E2-decenal (peak 8) and 4-oxo-E2-decenal (peak 9), which were absent from the whole-body hexane extracts of CSB. The Kovats Index and average percentage of each component identified from hexane extracts of CSB male and female whole-body, nymphs, and exuviae were listed in Table 1. Chemical structures identified and confirmed by authentic standards are presented in FIG. 2.

TABLE 1
Volatile organic compounds identified by GC-MS in hexane
extracts of male (M), female (F), nymph (N),
and exuviae (E) of cotton seed bug Oxycarenus hyalinippenis

| | | | Kovats | | Kovats | | | | | |
|---|---|---|---|---|---|---|---|---|---|---|
| | | | Index^{a} | | Index^{b} | | | | | |
| | | | HP- | HP- | Non- | | %^{c} | | | |
| No. | Compound | Mw | 5MS | Waxetr | polar | Polar | M | F | N | E |
| 1 | (E)-2-Hexenal^{d} | 98 | 852 | 1234 | 853 | 1230 | 0.5 | 1 | — | — |
| 2 | α-Pinene^{d,g} | 136 | 938 | 1032 | 939 | 1033 | 3 | 4 | — | — |
| 3 | 4-Oxo-(E)-2-hexenal^{d} | 112 | 960 | 1611 | 958 | 1599 | 0.5 | 0.4 | — | — |
| 4 | (E)-2-Hexenyl acetate^{d} | 142 | 1016 | 1343 | 1014 | 1344 | 0.2 | 0.7 | — | — |
| 5 | (E)-2-Octenal^{d,g} | 126 | 1059 | 1450 | 1060 | 1442 | 3 | 5 | 62 | 46 |
| 6 | 4-Oxo-(E)-2-octenal^{d} | 140 | 1145 | 1784 | | | 6 | 5 | 3 | 11 |
| 7 | (E)-2-Octenyl acetate^{d,g} | 170 | 1220 | 1546 | 1223 | 1474 | 7 | 10 | — | — |
| 8 | (E)-2-Decenal^{d} | 154 | 1266 | 1667 | 1267 | 1660 | — | — | 24 | 17 |
| 9 | 4-Oxo-(E)-2-decenal^{d} | 168 | 1348 | 1950 | | | — | — | 11 | 9 |
| 10 | (E)-α-Bergamotene^{e} | 204 | 1435 | 1605 | 1436 | 1609 | 5 | 7 | — | — |
| 11 | (Z, E)-α-Farnesene^{e,g} | 204 | 1502 | 1736 | 1505 | 1733 | 33 | 34 | — | — |
| 12 | Sesquiterpene 1^{f,g} | 204 | 1611 | 1906 | | | 9 | 8 | — | — |
| 13 | Sesquiterpene 2^{f,g} | 204 | 1691 | 1953 | | | 7 | 5 | — | — |

^{a}Calculated values.
^{b}Published values (NIST).
^{c}Percentages were averaged of 10 replicates by GC-FID with HP-5MS column.
^{d}Confirmed by authentic standards.
^{e}Identified by mass spectra and KI.
^{f}Unidentified compounds.
^{g}Reported major MTG Gland secretion compounds.

This example shows that using GC-MS, 13 major volatile compounds were identified as pheromone components in CSB: E2-hexenal (compound 1), α-pinene (compound 2), 4-oxo-E2-hexenal (compound 3), E2-hexenyl acetate (4) E2-octenal (compound 5), 4-oxo-E2-octenal (compound 6), E2 octenyl acetate (compound 7), E2-decenal (peak 8) and 4-oxo-E2-decenal (peak 9); and 4 compounds were identified as major CSB MTG gland secretions: E-a-bergamontene (10) (ZE)-α-farnesene (compound 11), farnesene isomer (compound 12) and sesquiterpene (compound 13).

### Example 2

### Field Tests Using Pheromones

Different pheromones or mixtures of pheromones were tested for their ability to attract CSB in the field.

Field tests were conducted by adding one or more of the identified pheromones to plastic vials and placing the vials in a cotton field with high CSB population, followed by counting the CSB caught after one (1) hour.

A field test was conducted using E2-octenal, E2-octenyl acetate, and a mixture of E2-octenal and E2-octenyl acetate. The compounds were placed in plastic vials in a cotton field with a high population of CSB. Many other bugs were also captured in the traps (numbers were not included). As seen in FIG. 3, the number of CSB caught in the traps were not significantly different among the different treatment groups, including the control (no treatment).

In a separate field test, a mixture of E2-octenal, 4-oxo-E2-octenal, and E2-octenyl acetate in a ratio of 1:2:7, as well as the single attractant component, 4-oxo-E2-8: ald, were tested. The compounds were formulated in rubber septa in a cotton field where the population of CSB was low. CSB formed the majority of insects caught in the traps. Trap specificity was much higher than in the test described above. In this test, as seen in FIG. 4, both the blend and 4-oxo-E2-8: ald trapped significantly more CSB than control (no treatment).

The results obtained in this Example show that a blend of 2-octenal, 4-oxo-E2-octenal, and E2-octenyl acetate, or 4-oxo-E2-8: ald attract CSB in a cotton field.

### Example 3

### Bioassay Materials and Methods

Additional materials and methods used are described in this Example.

Static Headspace Sampling by Solid-Phase Microextraction. The SPME holder and a red fiber with a 100-μm layer of polydimethylsiloxane (PDMS) coating were purchased from Supelco (Bellefonte, PA, USA) for headspace solid-phase microextraction (HS-SPME). USDA organic Gala apple fruit was obtained from local Aldi grocery store and fresh green leafy basil plant material from Soli Organic™ was purchased from MOM's Organic Market. The plant materials were 100% USDA Certified Organic and pesticide-free. Qorpak GLC-05728 clear glass 16 oz straight-sided tall jar with 63-400 green thermoset F217 PTFE lined cap was obtained from Amazon. A small hole (1 mm diameter) was drilled on the center of cap for SPME headspace volatile collection. The same instruments and methods employed in body-wash analyses were used for HP-SPME GC-MS analysis.

Dynamic Headspace Sampling (DHS) of CSBs. Volatiles were collected from live agitated and calm cotton seed bugs (CSBs) using a dynamic headspace collection apparatus. The experiment was conducted with four setups as follows: (a) 10 virgin males with 2 cotton seeds, (b) 10 virgin females with 2 cotton seeds, (c) 5 virgin males and 5 virgin females with 2 cotton seeds, and (d) a system blank containing only 2 cotton seeds (control). Headspace volatiles were collected from CSBs under two physiological states as indicated below. Agitated State: Volatiles were collected for the first two hours, during which the CSBs were agitated every 15 minutes by gently shaking the glass apparatus, and Calm State: A second volatile collection was conducted over 24 hours, leaving the CSBs undisturbed to maintain a calm state.

The headspace collection apparatus consisted of three main components: Bottom Glass Chamber: With a ground glass fitting to hold the structure. Central Glass Tube: A 7 mm inner diameter (I.D.) tube containing the test material (CSBs and cotton seeds). A thin mesh was used to contain the insects within this tube, and Glass Absorbent Filter: A glass filter (10/30 Inner Joint, ACE Glass) holding approximately 80-100 mg of Super Q adsorbent, connected to the central tube via a ground glass fitting. The entire setup was clamped vertically, and a vacuum pump connected to the tip of the glass adsorbent filter drew air through the system at a rate of 500 mL/min. This allowed volatiles released by the CSBs to be captured on the Super Q adsorbent. The collected volatiles were eluted from the Super Q adsorbent using ˜200 μl HPLC grade hexane (Millipore Sigma). Samples were injected into the gas chromatography-mass spectrometry (GC-MS) instrument for analysis on the same day to ensure the integrity of the volatile profile.

Dual-Choice Refuge Assay. A two-choice arena was constructed of a polystyrene Petri dish (ϕ=8.5 cm, H=1.5 cm) with two holes (ϕ=1 cm) equidistant from the center of the dish (2.75 cm). Under the dishes, the holes were covered with a screen and a 2 mL GC clear glass vial cap without septum was attached using hot plastic glue. FIG. 6 shows a schematic diagram of an arena. The cap served the purpose of affixing a borosilicate vial containing the test materials (exuviae extracts and a solvent control). Consequently, the screen acted as a barrier, preventing nymphs and adults from making direct contact with the vial interiors. Their behavioral preferences were exclusively influenced by volatile organic compounds (VOCs) emitted from the vials. Inside the Petri dish, a single cotton seed was placed on top of each screen-covered hole, serving as the resting place for CSB.

Preparation of Exuviae Extracts. To collect fresh exuviae from final instar nymphs, 5th instar nymphs were individually placed into glass vials (7.5 mL). Exuviae were collected on the day of eclosion, stored in 2 mL GC-clear glass vials, and kept at −20° C. The exuviae were used within two days of collection to ensure freshness.

For preparing exuviae extracts, hexane was added to the 2 mL GC glass vial containing all collected exuviae approximately one hour before the experiment. The exuviae were soaked in hexane for 30 minutes at room temperature. Afterward, the hexane solution was carefully transferred to a new 2 mL GC glass vial, and the exuviae were discarded. A control hexane solvent, without exuviae, was prepared simultaneously. Filter paper strips (2×1 cm) were treated with the extracts by applying 20 μL of the exuviae solution (equivalent to five exuviae) in a fume hood. The strips were left in the hood for 7-10 minutes to allow the hexane solvent to evaporate. Similarly, control filter paper strips were prepared by applying 20 μL of pure hexane.

Both the treated and control filter paper strips were placed into separate 2 mL GC glass vials, which were then attached to the bottom of the petri dish arena using the vial caps. Each petri dish contained two cotton seeds: one positioned above the exuviae extract side and the other above the control side, as shown in the schematic diagram on FIG. 6. A single adult cotton seed bug (CSB) or nymph was cold-immobilized for one minute before being gently placed in the center of the arena. The petri dish was covered with a lid containing small holes to prevent the buildup of volatile compounds within the arena. After 40 minutes, the position of the insect on each cotton seed was recorded. To minimize positional bias, the placement of the test materials (vials beneath the petri dish) was randomized. After 40 minutes, three attributes were recorded as follows: (a) Responders: CSBs that made a choice was considered as responders, and (b) Side preference: CSBs that made choice of cotton seed located either above the exuviae extract or hexane control was used to determine side preference. Each insect was used only once during the experiment. 4^{th}/5^{th} instar nymphs were used to measure the responses of nymphs. The dual-choice refuge assay was also validated with nymph (n=15), mated male (n=15), and mated female (n=15) with two blank vials to measure the side bias. After each replicate, all petri dishes were thoroughly washed with water and allowed to air dry at room temperature. All assays were conducted in a growth chamber maintained at 60% relative humidity and 25±1° C., under diffused white light, 3-6 hours after the beginning of the photo-phase.

The dual-choice refuge assay, was conducted over 40 minutes, the final location of adult and juvenile CSBs was assessed at the end of the experiment. In contrast, the dual-choice oviposition assay, designed to evaluate gravid females' oviposition site selection, was conducted over three consecutive days to record the number of eggs laid, as described herein.

Dual-choice Oviposition Assay: To examine the gravid female CSB oviposition site choice assay, dual-choice oviposition assay was used. Same petri dish arena used for the dual-choice refuge assay shown in FIG. 6 was used to measure the gravid female oviposition site preference. Exuviae hexane extracts and solvent controls were prepared at least one hour before the experiments by applying 40 μL of the exuviae solution (equivalent to ten exuviae) or 40 μL of hexane solvent (control) onto individual Whatman filter paper strips (4×2 cm) under a fume hood, as previously described. After adding the extracts on to the filter paper, it was kept in the fume hood for 7-10 min to remove the hexane solvent from the filter paper. Both the treated and control filter paper strips were placed into separate 2 mL GC glass vials, which were then attached to the bottom of the petri dish arena using the vial caps.

To obtain mated gravid females for the assay, approximately 50 six-day-old unmated males and females were housed together in a container with green beans and water for four days to ensure successful mating. During this period, cotton seeds were withheld to delay oviposition. On the fifth day, a single mated female was introduced into an arena containing two cotton seeds: one positioned above the solvent (side-1) and the other above the exuviae extract odor (side-2). A small water wick (1 cm) and a piece of green bean were also placed inside the arena. Each female was monitored over a three-day period, during which the number of eggs laid on the cotton seeds on each side was recorded. The odor source and cotton seeds were replaced every 24 hours. After the three-day observation period, cotton seeds with eggs were individually transferred to separate 7 mL glass vials for egg counting. The eggs on each side were counted under a microscope, and their numbers were tracked for 10-12 days until no emergence was observed for two consecutive days, ensuring the accuracy of the egg count. A total of 30 females were tested in this experiment (n=30). Control experiments were conducted to assess side bias and preference for hexane. For this, a single mated gravid female was introduced into an arena containing two cotton seeds: one positioned above the solvent (side-1) and the other above a clean filter paper without solvent (side-2). A total of 15 females were tested in this control experiment (n=15).

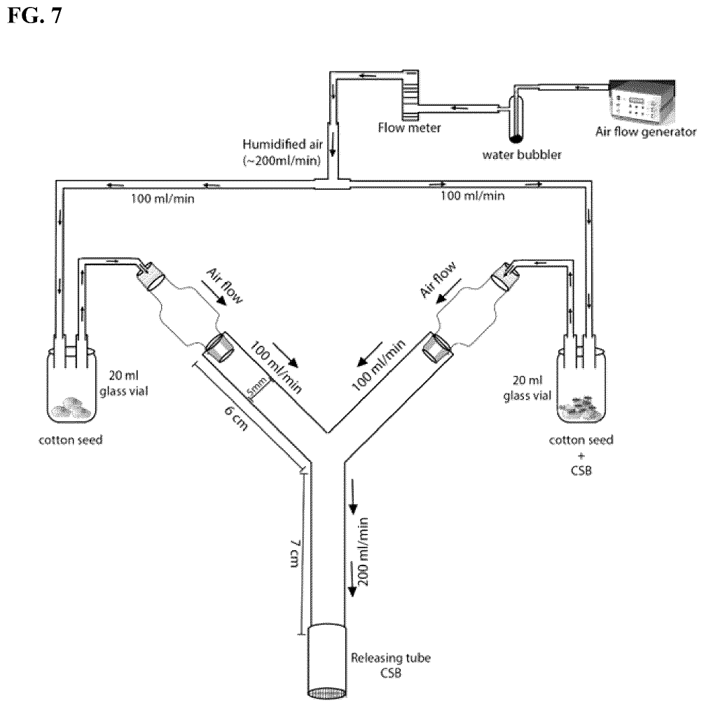

Y-Tube Olfactometer Bioassays: A custom-made horizontal Y-tube glass olfactometer was used for all behavioral assays. A schematic diagram of a Y-tube olfactometer is shown in FIG. 7. The Y-tube was horizontally-mounted on a white platform, and charcoal-filtered, humidified air was pushed through the system at a flow rate of 200 mL/min using a stimulus controller (CS 55, Ockenfels Syntech GmbH, Germany). The olfactometer was positioned horizontally, with insects introduced through a releasing tube connected to the downwind end. The releasing tube was constructed from a 10 mL pipette tip, and insects were placed inside at least one hour before the experiment to acclimate in an incubator under diffused white light, where all bioassays were performed.

The releasing tube, containing an acclimated cotton seed bug (CSB), was attached to the olfactometer, and the insect's movement was observed for 5-6 minutes. A response was defined as a CSB making a choice by moving at least 5 cm into either arm of the olfactometer within the observation period. The side preference was determined by the CSB's choice between the exuviae extract odor arm and the control arm. CSBs that did not reach this point within 5-6 minutes were categorized as non-responders.

To eliminate positional bias, the odor source position was randomized between the right and left arms for each replicate. Odor sources were contained in 20 mL scintillating glass vials, attached to each arm of the olfactometer. Exuviae hexane extracts and solvent controls were prepared at least one hour before the experiments by applying 20 μL of the exuviae solution (equivalent to five exuviae) or 20 μL of hexane solvent (control) onto individual Whatman filter paper strips under a fume hood, as described above. Bioassays with control filter papers in both sides of the olfactometer were conducted (n=10-15 per treatment). The glass olfactometers were cleaned with acetone after every 2-3 bioassays.

Live Insect Odor Source Preparation. A glass Y-tube olfactometer was used to measure the response and preference of test insects toward live insect odors. Insects were prepared 60 minutes before testing by placing a single insect in a release tube, which was attached to the olfactometer. Tested insects included males and females (6-10 days old) and 4th/5th instar nymphs. Each insect was used only once, and the olfactometer was cleaned with acetone every three replicates.

Calm Nymph VOCs: Fifty 4th/5th instar nymphs were placed in a 20 mL scintillation vial with three cotton seeds and a moist cotton wick. Nymphs were left undisturbed for 48 hours before testing.

Calm Male and Female VOCs: Twenty unmated males and 20 unmated females (8-12 days old) were placed in a 20 mL scintillation vial with three cotton seeds and a moist cotton wick. The insects were left undisturbed for 48 hours before testing.

Agitated Male and Female VOCs: Twenty unmated males and 20 unmated females (8-12 days old) were introduced into a 20 mL scintillation vial with three cotton seeds and a moist cotton wick 15-30 minutes before testing.

Calm Mated Male VOCs: Forty mated males were placed in a 20 mL scintillation vial with three cotton seeds and a moist cotton wick. The insects were left undisturbed for 48 hours before testing.

Agitated Mated Male VOCs: Forty mated males were introduced into a 20 mL scintillation vial with three cotton seeds and a moist cotton wick 15-30 minutes before testing. The vial was shaken gently for 5 seconds before testing to induce agitation.

Additionally, a control vial was prepared simultaneously with each odor vial for every treatment, using a 20 mL scintillation glass vial containing three cotton seeds and a moist cotton wick without insects.

### Example 4

bioassay RESULTS

The measured behavioral responses under different conditions are described here.

Dual-choice Refuge Assay: Behavioral responses of cotton seed bugs (CSBs) were evaluated in a dual-choice refuge assay with the following groups: nymphs (n=30), unmated males (n=30), mated males (n=30), unmated females (n=30), and mated females (n=30). (a) Responders: The percentage of insects that were activated and made a choice between the control and treatment sides. (b) Side Preference: The percentage of insects that selected either the control or treatment side. Statistically significant differences were observed according to Fisher's Exact Test (two-tailed).

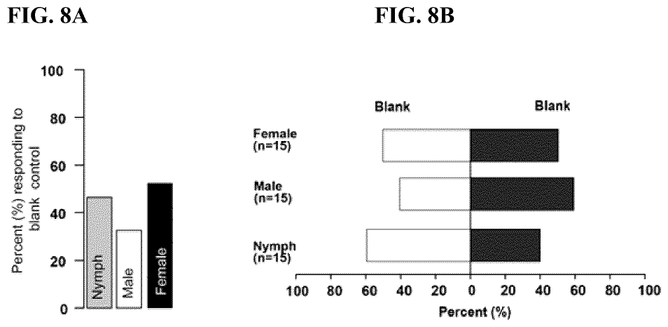

A dual-choice refuge assay was conducted with nymphs, mated males, and mated females of cotton seed bugs (CSBs). As seen in FIG. 8A, among the 15 individuals tested for each group, less than 50% responded, as the majority of CSBs remained non-responsive. FIG. 8B shows that of those that responded none of them exhibited a significant side bias when presented with two blank vials. FIG. 9A shows that when offered a choice between exuviae extract and hexane, over 60% of the tested groups responded. Notably, a seen in FIG. 9B, nymphs and gravid females showed a significant preference for the cotton seed located on the exuviae extract side (Fisher's exact test, two-tailed: P<0.0001 for both groups). In contrast, unmated males, unmated females, and mated males demonstrated no clear preference. Interestingly, although not statistically significant, unmated males and females appeared to prefer taking refuge on the cotton seed positioned above the hexane side.

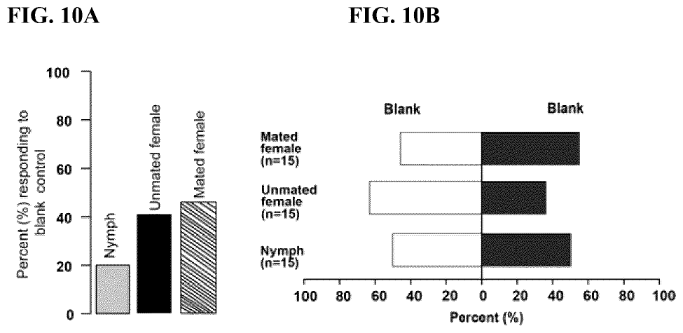

Y-tube Olfactometer Assay: To further investigate the effect of mating on female responses to exuviae extract, Y-tube olfactometer bioassays were conducted with unmated females (n=20), mated females (n=20), and 5th instar nymphs (n=20). As seen in FIG. 10 and FIG. 10B, initial control experiments, using clean filter papers on both sides of the olfactometer confirmed the absence of side bias as very few (<46%) responded with no significant side preference.

Behavioral response of nymph (n=20), unmated female (n=20), and mated female (n=20) towards Exuviae Extracts in a Y-tube olfactometer. A response was defined as a CSB making a choice by moving at least 5 cm into either arm of the olfactometer within the observation period. The side preference was determined by the CSB's choice between the exuviae extract arm and the control arm. Nymphs and gravid females are significant at ** P=0.007, and *P=0.026, respectively according to Fisher exact test. Consistent with the previous dual-choice refuge assay, 5th instar nymphs and mated females displayed a strong attraction to exuviae extracts, with significantly more individuals choosing the exuviae extract side of the olfactometer (Fisher's exact test, two-tailed: p=0.007 and p=0.026, respectively; FIG. 11A and FIG. 11B). In contrast, no significant preference was observed for unmated females.

The solvent had no discernible effect on the behavior of gravid female cotton seed bugs (CSBs), as there was no significant difference in the average number of eggs laid on the cotton seeds located on the clean filter paper side compared to the solvent side (as seen on FIG. 12A). In contrast, FIG. 12B shows that the presence of juvenile-associated odors strongly influenced the choice of egg-laying sites. Significantly more gravid females laid their eggs on the cotton seeds positioned on the exuviae extract odor side of the arena compared to the solvent side (Mann-Whitney test, two-tailed: P<0.0001).

This behavior highlights conspecific attraction, a form of social information use where individuals are drawn to the presence of conspecifics, which often indicate high-quality sites or resources. Such attraction results in the aggregation of individuals with similar ecological or reproductive needs.

FIG. 12A shows the average number of eggs per female laid on cotton seeds positioned above a filter paper without solvent (filter blank) compared to a solvent blank (n=15). FIG. 12B shows the average number of eggs per female laid on cotton seeds positioned above the solvent blank and the exuviae extract side (n=30), with a significant difference observed (P<0.0001) according to a Mann-Whitney test (two-tailed).

Response to Calm Nymph VOCs: Behavioral responses of nymph (n=20), male (n=20), and female (n=20) towards calm nymph associated VOCs in a Y-tube olfactometer. Responders: The percentage of insects that were activated and made a choice to either go to control or treatment side. Side preference: The percentage of insects that selected either side. Statistically significant differences were observed according to Fisher's Exact Test (two-tailed). As seen in FIG. 13A and FIG. 13B, a significant proportion (70%) of 4th/5th instar nymphs responded to calm nymph-associated odors, with a significantly higher number choosing the nymph odor side of the olfactometer arm (Fisher's exact test, two-tailed: p=0.0025). In contrast, approximately 50% of males and females responded, with a larger proportion preferring the control arm, although this preference was not statistically significant.

Response to Calm Male and Female VOCs: Behavioral response of Nymph (n=20), male (n=20), and female (n=20) towards calm male (20)+Female (20) VOCs in a Y-tube olfactometer were determined. Responders: The percentage of insects that were activated and made a choice to either go to control or treatment side. Side preference: The percentage of insects that selected either side. Statistically significant differences were observed according to Fisher's Exact Test (two-tailed). As seen in FIG. 14A and FIG. 14B, over 60% of nymphs, males, and females responded in the Y-tube olfactometer. Among them, only males and females showed a significant preference for the calm male and female odors, selecting the corresponding Y-tube arm (Fisher's exact test, two-tailed: p=0.0047 and p=0.0025, respectively). In contrast, nymphs did not exhibit a significant preference for male and female odors compared to the control.

Response to Agitated Male and Female VOCs: The behavioral response of Nymph (n=20), male (n=20), and female (n=20) towards Agitated male (20)+Female (20) VOCs was measured in a Y-tube olfactometer. (a) Responders: The percentage of insects that were activated and made a choice to either go to control or treatment side. (b) Side preference: The percentage of insects that selected either side. Statistically significant differences were observed according to Fisher's Exact Test (two-tailed). A seen in FIG. 1A and FIG. 15B, over 60% of males and females responded, with over 90% actively avoiding the olfactometer arm containing agitated male and female odors (Fisher's exact test, two-tailed: p<0.0001). This behavior contrasts with earlier findings, where most males and females were attracted to calm male and female VOCs. This shift from attraction to avoidance suggests that calm and agitated CSBs emit distinct VOC profiles. Interestingly, only a small proportion of nymphs responded, and those that did showed no preference for the arm containing agitated male and female odors.

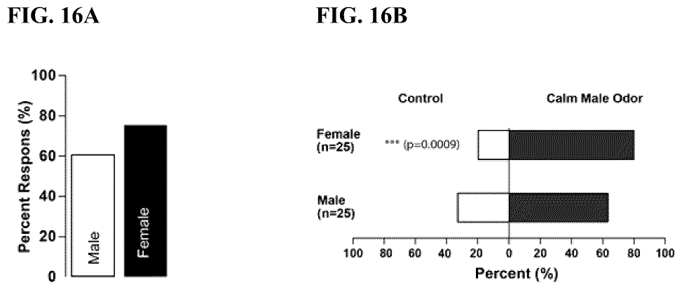

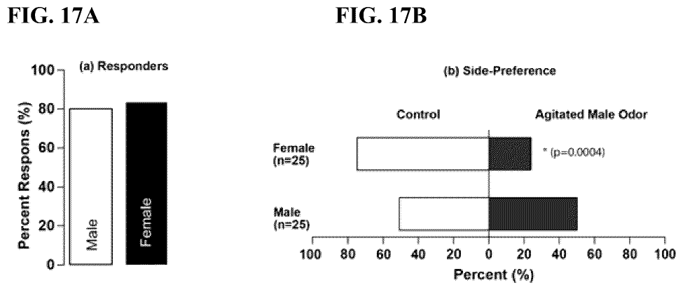

Response to Calm and Agitated Male VOCs: The behavioral response of male (n=25), and female (n=25) towards calm male (40) VOCs in a Y-tube olfactometer was measured. Responders: The percentage of insects that were activated and made a choice to either go to control or treatment side. Side preference: The percentage of insects that selected either side. Statistically significant differences were observed according to Fisher's Exact Test (two-tailed). FIG. 16A and FIG. 16B show that over 60% of both males and females responded in the experiment. Among females, over 80% were attracted to the olfactometer arm containing odors from calm males (Fisher's exact test, two-tailed: p=0.0008). In contrast, as seen in FIG. 17A and FIG. 17B, when exposed to odors from agitated males, more than 80% of females actively avoided these odors (Fisher's exact test, two-tailed: p=0.0004). The results shown in these figures strongly suggest that females are attracted to calm males while avoiding agitated ones. For males, although there was a tendency to be attracted to calm male odors, the preference was not statistically significant. Interestingly, males showed no preference for either side when exposed to agitated male odors.

We claim:

1. A cotton seed bug (CSB) Oxycarenus hyalinipennis-attracting composition comprising at least one of (E)-2-Hexenal, α-Pinene, 3. 4-Oxo-(E)-2-hexenal, (E)-2-Hexenyl acetate, (E)-2-Octenal, 6. 4-Oxo-(E)-2-octenal, (E)-2-Octenyl acetate, or a combination thereof; and optionally comprising an insecticide; wherein the composition is effective at attracting CSB.

2. The CSB attracting composition of claim 1, wherein the composition contains at least one Malvaceae plant or plant part, and comprises at least two CSB attractants selected from E2-octenal, 4-oxo-E2-octenal, E2-octenyl acetate, 4-oxo-E2-hexnal, E2-hexenal, E2-hexenyl acetate, E2-decenal, 4-oxo-E2-decenal, α-pinene, or a combination thereof; and optionally comprises an insecticide.

3. A CSB repelling composition comprising at least one of (E)-α-Bergamotene, (Z, E)-α-Farnesene, Sesquiterpene 1, Sesquiterpene 2, or a mixture thereof.

4. A CSB oviposition pheromone comprising at least one of (E)-2-Octenal, 4-Oxo-(E)-2-octenal, (E)-2-Octenyl acetate, (E)-2-Decenal, or a mixture thereof.

5. The CSB-attracting composition of claim 2, wherein the composition comprises 4-oxo-E2-octenal, E2-octenal, and E2 octenyl acetate.

6. The CSB-attracting composition of claim 1, wherein the composition comprises at least three CSB attractants selected from E2-octenal, 4-oxo-E2-octenal, E2-octenyl acetate, 4-oxo-E2-hexnal, E2-hexenal, E2-hexenyl acetate, E2-decenal, 4-oxo-E2-decenal, α-pinene, or a combination thereof; and optionally an insecticide.

7. The CSB-attracting composition of claim 6, wherein the composition comprises 4-oxo-E2-octenal, E2-octenal, and E2 octenyl acetate.

8. A method for attracting and/or monitoring the presence of cotton seed bug (CSB) in a field, the method comprising placing an effective amount of at least one CSB attractant selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof on a surface in the field, and determining that at least one CSB is attracted when at least one CSB is observed touching or near the surface containing the CSB attractant.

9. The method of claim 8, wherein the surface is at least a part of a trap.

10. The method of claim 8, wherein the CSB-attractant in the composition is 4-oxo-E2-octenal.

11. The method of claim 8, wherein at least two CSB attractants selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof are placed on the surface in the field.

12. The method of claim 9, wherein at least three CSB attractants selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof are placed on the surface in the field.

13. The method of claim 12, wherein the at least of 4-oxo-E2-octenal, E2-octenal, and E2 octenyl acetate are placed on the surface in the field.

14. The method of claim 8, wherein the field contains a Malvaceae plant or plant part, or is in the vicinity of a field that contains a Malvaceae plant or plant part.

15. The method of claim 14, wherein the Malvaceae plant or plant part is a cotton plant or plant part.

16. A device comprising at least one CSB attractant selected from E2-octenal, 4-oxo-E2-octenal, E2-octenyl acetate, 4-oxo-E2-hexnal, E2-hexenyl acetate, E2-hexenal, E2-decenal, 4-oxo-E2-decenal, α-pinene, or a combination thereof and a trap.

17. The device of claim 16, wherein the at least one CSB attractant is 4-oxo-E2-octenal.

18. The device of claim 16, wherein the device comprises E2-octenal, and E2-octenyl acetate.

19. The device of claim 16, wherein the device comprises 4-oxo-E2-octenal, E2-octenal, and E2-octenyl acetate.

20. The device of claim 16, wherein the device further comprises an insecticide.
